(19) United States
(12) Patent Application Publication
(10) Pub. No.: US 2014/0196354 A1
(43) Pub. Date: Jul. 17, 2014

(54) FISHING LURE

(71) Applicant: KENT PARTAIN, Deltona, FL (US)

(72) Inventor: KENT PARTAIN, Deltona, FL (US)

(21) Appl. No.: 13/741,453

(22) Filed: Jan. 15, 2013

(51) Int. Cl. A01K 85/00

(52) U.S. Cl. CPC A01K 85/00
USPC 43/42.24

(57) ABSTRACT

A fishing lure includes a shape that resembles an insect having a head that is formed by a weight, a main body formed by a colorful fabric, a plurality of elongated legs radiating outward from the main body, and an elongated fishing hook having a first end that is in communication with the head, and a second end having a barbed section.

### TECHNICAL FIELD

The present invention relates generally to the field of fishing equipment, and more particularly to a fishing lure and a method of assembling the fishing lure onto a fishing line.

### BACKGROUND

The statements in this section merely provide background information related to the present disclosure and may not constitute prior art.

Fishing lures function to attract fish towards a hook upon which the fish may be caught. When selecting a fishing lure for use, an angler may consider a number of variables, for example, the water environment in which a fishing lure is to be used, the type of fish which is sought to be caught, and the type of fishing system within which the fishing lure will be used.

Conventional fishing lures differ in size, shape, material, color, smell and buoyancy; and additional features of some fishing lures include mechanisms to produce noise, light, vibrations, or a liquid attractant. In either case, fishing lures are often constructed to attract a certain type/class of fish, and will include characteristics tailored to that class.

Bass, crappie and bluegill are among the most popular types of freshwater fish caught by anglers. As bass are typically the largest in size, there are a large number of custom lures designed specifically for them, whereas bluegill and crappie are often fished with the same type of generic lure. To this end, these conventional lures often include minimal markings and a feather tail that are designed to affect the hydrodynamics of the lure moving through the water in order to simulate the motions of a dying minnow. While this suits the feeding habits of crappie well, those of skill in the art realize that the striking habits of bluegill are different from that of the crappie.

Bluegills, which are often smaller than crappies, are believed to have the best eyesight of any freshwater fish, and therefore are extremely attracted to colors and markings. In a natural environment, bluegills prefer to eat small invertebrates and insects such as muscles, flies and grasshoppers, for example, which move through the water differently than minnows.

Accordingly, it would be beneficial to provide a fishing lure which can simulate the natural prey of the bluegill fish that does not suffer from the above drawbacks.

### SUMMARY OF THE INVENTION

The present invention is directed to a fishing lure. One embodiment of the present invention can include a shape that resembles an insect having a head that is formed by a weight, a main body formed by a colorful fabric, a plurality of elongated legs radiating outward from the main body, and an elongated fishing hook having a first end that is in communication with the head, and a second end having a barbed section.

Another embodiment of the present invention can include a plurality of colorful markings.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a side view of a fishing lure in accordance with one embodiment of the invention.

FIG. 2 is a bottom perspective view of the fishing lure in accordance with the one embodiment of the invention.

FIG. 3 is a front perspective view of the fishing lure in accordance with the one embodiment of the invention.

FIG. 4 is a view of the fishing lure in operation, in accordance with the one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

Identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

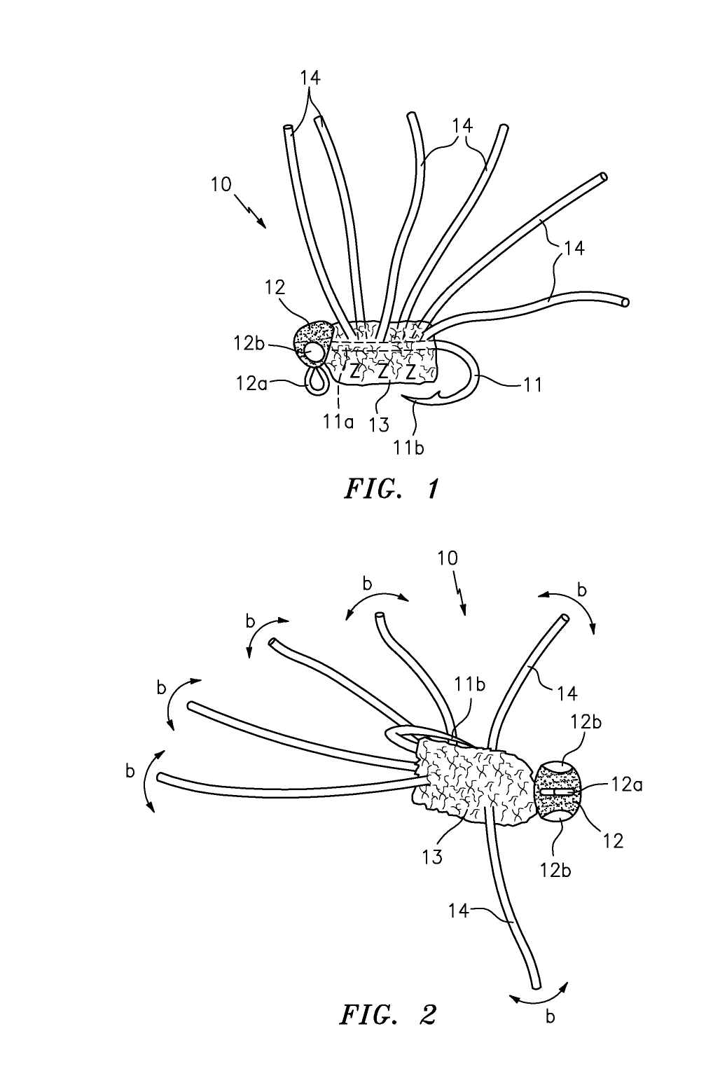

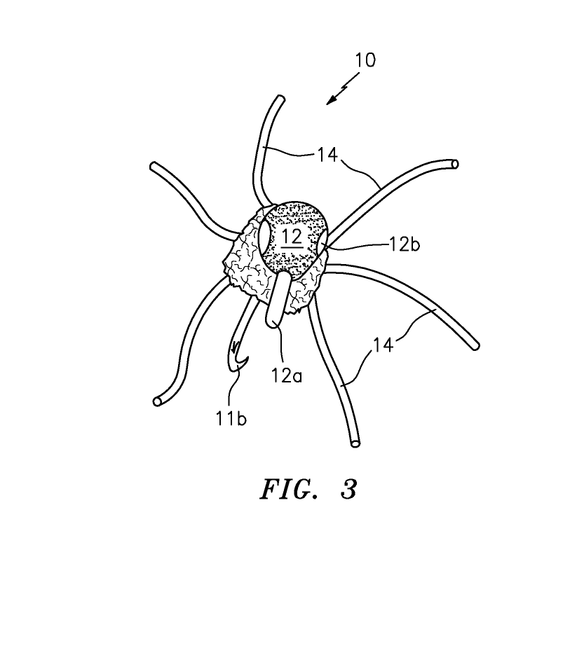

FIGS. 1-3 illustrate one embodiment of a fishing lure 10 that is useful for understanding the inventive concepts disclosed herein. As shown, the lure can include a shape that resembles an insect having a head section, a main body section, and a plurality of elongated legs.

In one embodiment, the lure can be constructed about an elongated fishing hook 11 having a first end 11a and a barbed second end 11b. A metallic, preferably lead weight 12 can be formed around the first end of the fishing hook 11a so as to provide the appearance of a bug head. To this end, the led weight can be constructed to include any number of different colors having an eyelet 12a for securing the lure to a fishing line and a pair of bright markings 12b to simulate the look of eyes. The led weight 12 can be secured to the fishing hook in any number of conventional manners such as through compression (e.g., clamping to the hook with pliers), welds, adhesives and the like.

A main body 13 can be formed about the central portion of the hook 11 and can preferably be constructed from an elongated strand of soft, colorful fabric material such as chenille® yarn or fabric for example. In one embodiment, the fabric material can be wrapped around the hook beginning near the second end 11b until terminating at the first end 11a. The wrapped material can then be secured to the hook in any number of conventional manners such as a knot or a waterproof adhesive, for example. Additionally, the main body can include a plurality of markings and/or different colored portions Z to attract the fish.

A plurality of elongated, resilient and flexible legs 14 can radiate outward from the main body in all directions e.g., 360 degrees in both a horizontal and vertical axis (See FIG. 3). In one preferred embodiment, legs 14 can be constructed from several pieces of thin strands of live rubber that are tied to the hook 11 and/or the fabric material 13. Each of the legs being extremely flexible, elastic and malleable, so as to emulate the look and movement of an insect underwater.

Although described above as separate individual elements, other embodiments are also contemplated. For example, in one alternate embodiment, the hook 11 and weight 12 can be constructed and formed together as one continuous element through known manufacturing processes.

While the dimensions of the elements are not critical, in the preferred embodiment the hook 11 can comprise a standard #8 sickle fishing hook, the weight 12 can comprise a 1/64^{th} oz. no collar head, the fabric main body 13 can include a length (horizontal in FIG. 1) of 1 cm and each of the legs 14 can include a length of approximately 2.5 centimeters. Of course, the above noted dimensions can be scaled upward and downward depending on the size of the fish being targeted.

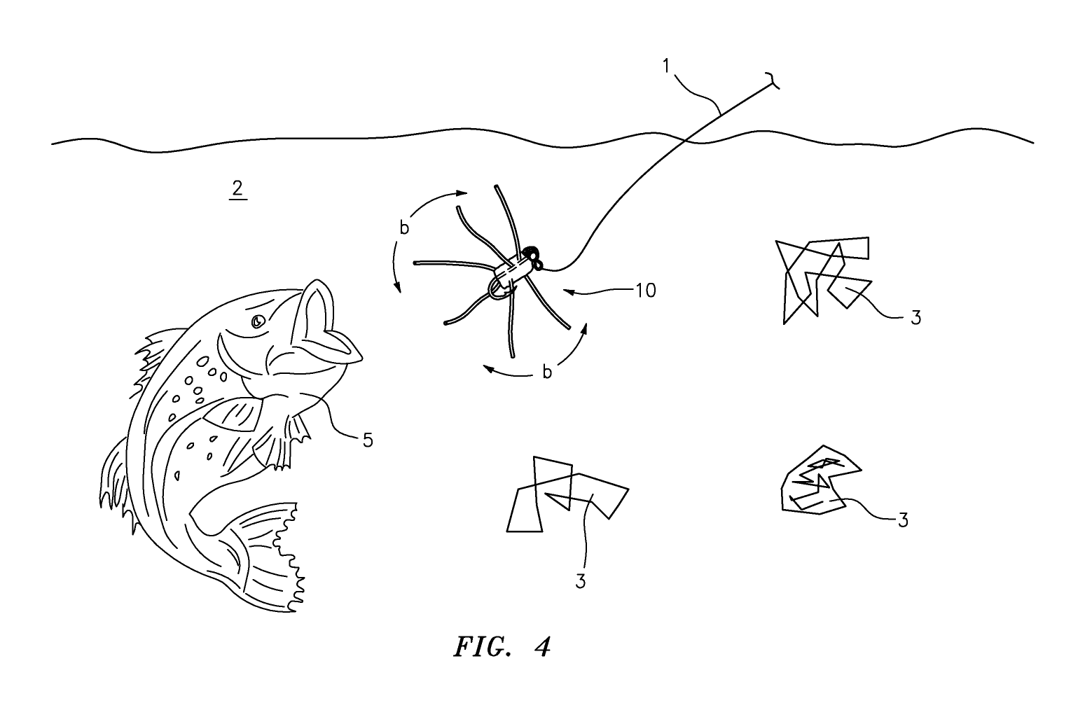

FIG. 4 illustrates one embodiment of the lure 10 in operation. As shown, the lure can be secured to fishing line 1 in a conventional manner using the eyelet 12a. With the absence of a tail, the legs 14 flex and bend, see arrow b, so as to allow the lure to move erratically in all directions underwater 2 in much the same way as a live insect would. More specifically, owing to the ability of each leg to move independently in any direction when acted upon by the water, the legs function to affect the hydrodynamics of the lure in a negative manner, thus making it move through the water much less efficiently than a standard lure with a tail. As such, the negative hydrodynamic efficiency is what causes the erratic movement, and therefore resembles the movement of a live insect.

Additionally, the plurality of elongated flexible legs which extend about the second end of the hook 11b serve two important purposes. As shown, the legs act to disguise the appearance of the hook, and further as a barrier to prevent the hook from making contact with underwater debris 3 such as driftwood, algae and/or seaweed, for example. Such features work in harmony to increase the likelihood that the angler will catch the desired fish 5, as opposed to losing the lure in the shallows.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A fishing lure, comprising:
an elongated fishing hook having a first end a central portion and a barbed second end;
a metallic weight secured to the first end of the fishing hook;
an eyelet secured to the weight, said eyelet being configured to be secured to a fishing line;
a main body formed about the central portion of the fishing hook, said main body being constructed from a colorful fabric material; and
a plurality of individual elongated flexible legs radiating outward from the main body,
wherein the weight, main body and legs form the shape of an insect.

2. The fishing lure of claim 1, wherein the weight is constructed from led.

3. The fishing lure of claim 1, further comprising:
a pair of bright markings disposed on either side of the metallic weight, said markings being positioned so as to resemble eyes.

4. The fishing lure of claim 1, wherein each of the individual legs are constructed from thin strands of elongated rubber, and are configured to flex in any direction.

5. The fishing lure of claim 1, wherein each of the individual legs are configured to disrupt a smooth movement of the lure through water, so as to emulate a movement of a live insect.

6. The fishing lure of claim 1, wherein each of the individual legs are constructed from a resilient material configured to act as a barrier against the hook making contact with underwater debris.

7. The fishing lure of claim 1, wherein the main body further includes a plurality of colorful markings configured to attract the attention of a fish.
